(19) United States
(12) Patent Application Publication
(10) Pub. No.: US 2010/0156926 A1
(43) Pub. Date: Jun. 24, 2010

(54) IMAGE DISPLAY DEVICE AND IMAGE DISPLAY METHOD

(76) Inventors: Norimasa FURUKAWA, Tokyo (JP); Yoshihiko Kuroki, Kanagawa (JP); Ichiro Murakami, Tokyo (JP); Mitsuyasu Asano, Tokyo (JP); Tomohiro Nishi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/634,933

(22) Filed: Dec. 10, 2009

(30) Foreign Application Priority Data
Dec. 22, 2008 (JP) P2008-326539

(51) Int. Cl. G09G 5/02

(52) U.S. Cl. 345/589

(57) ABSTRACT

An image display device is provided, with less color breaking in the field sequential method. A color component image with a relatively high luminance level is extracted as a fundamental image from an input image. A differential image is obtained by subtracting color component of the fundamental image from an input image, and is decomposed into a plurality of color components. The differential image for each color component is divided into two. The fundamental image is displayed at a middle timing of a frame period. The half-divided differential images are displayed at timings before and after the middle timing for the fundamental image so that the half-divided differential image with higher luminance level with consideration for visibility characteristic is displayed at a timing closer to the middle timing for the fundamental image.

### BACKGROUND OF THE INVENTION

1. Field of the Invention

The present invention relates to an image display device and an image display method for performing color image display by a field sequential method.

2. Description of the Related Art

A color image display method is roughly divided into two methods depending on additive color mixture methods. A first method is an additive color mixture method based on a spatial color mixture principle. More specifically, respective sub pixels of three primary colors R (red), G (green) and B (blue) of light are finely arranged in a plane so that respective color light are indiscriminative in terms of spatial resolution of human eyes, so that the colors are mixed in one screen to obtain a color image. The first method is applied to most of currently commercialized display types such as a Braun tube type, a PDP (Plasma Display) type, and a liquid crystal type. When the first method is used to configure a display device of a type where light from a light source (backlight) is modulated to perform image display, for example, a display device using elements, which are not self-luminous as typified by liquid crystal elements, as modulating elements, the following difficulties occur. That is, three systems of drive circuits are necessary in correspondence to respective RGB colors for driving the sub pixels in one screen. Moreover, RGB color filters are necessary. Furthermore, existence of the color filters decreases use efficiency of light to ⅓ because light from a light source is absorbed by the color filters.

A second method is an additive color mixture method using temporal color mixture. More specifically, the RGB three primary colors of light are divided along a time axis, and planar images of the respective primary colors are sequentially displayed with time (time-sequential). In addition, each screen is changed at a rate too high for human eyes to recognize the screen in terms of temporal resolution of human eyes so that each color light is indiscriminative due to temporal color mixture based on a storage effect in a temporal direction of eyes, consequently a color image is displayed by using temporal color mixture. The method is typically called field sequential method.

When a display device with the second method is configured using elements, which are not self-luminous as typified by, for example, a liquid crystal element, as modulating elements, the following advantage is given. That is, since a state where a screen color is monochrome at each moment is obtained, spatial color filters for discriminating colors in a plane for each pixel are unnecessary. Light from a light source is changed into monochrome light to a black-and-white display screen, and each screen is changed at a rate too high to recognize the screen. In addition, since a display image can be sequentially changed according to an R signal, a G signal and a B signal in conjunction with changing backlight using a storage effect in a temporal direction of eyes into, for example, each monochrome of RGB, only one drive circuit system is necessary.

Furthermore, color selection is performed by temporally changing a color, and color filters are unnecessary as described before, leading to an effect of reducing passing loss of quantity of light. Therefore, the second method is currently mainly used for a modulation method of a high-luminance high-heat light source such as a projector (projection display method) in which reduction in quantity of light tends to cause fatal heat loss. In addition, the second method is variously investigated because of its merit of high use efficiency of light.

However, the second method has a visually serious drawback. Specifically, a basic principle of display of the second method is that each screen is changed at a rate too high for human eyes to recognize the screen in terms of temporal resolution of human eyes. However, RGB images, which are sequentially displayed with time, are not well mixed due to complicated factors including limitation in an optic nerve of an eye ball, and an image recognition sense of a human brain. As a result, when an image having low color purity such as a white image is displayed, or when tracking view is performed to movement display of a display object within a screen, each primary-color image is sometimes viewed as a residual image or the like, causing a display phenomenon of color breaking giving extreme discomfort to a viewer.

Various measures for overcoming the drawback of the second method have been proposed in the past. For example, a drive method is proposed, in which color sequential drive is performed while removing color filters, and frames of white display are inserted to prevent color breaking so as to achieve continuous spectral energy stimulus on a retina, leading to reduction in color breaking.

As such a related art, for example, a technique is known, in which a field for mixing a white light component period is provided in each field of RGB field sequential, thereby reduction in color breaking is achieved (for example, refer to Japanese Unexamined Patent, Publication No. 2008-020758). As another related art, a technique is known, in which a white component is extracted, and a W field is additionally provided between RGBRGB sequence to insert the white component, so that 4-sequential frames of RGBWRGBW are formed so as to prevent color breaking (for example, refer to Japanese Patent No. 3912999). Moreover, a technique is known, in which image information is extracted, and color origin coordinates of each primary color (basic color) itself to be processed are changed, so that color breaking is prevented (for example, refer to Japanese Patent No. 3878030). In addition, ideas for improving display in the field sequential method are variously proposed (refer to Japanese Unexamined Patent, Publication No. 2008-310286, 2007-264211 and 2008-510347, and Japanese Patent No. 3977675).

### SUMMARY OF THE INVENTION

The technique described in Japanese Unexamined Patent, Publication No. 2008-020758 has a difficulty that if a display image region having high color purity exists in a display screen, mixing of white light occurs, which degrades color purity of the display image region, and a correct color is hardly reproduced. If color breaking is intended to be reduced while keeping color purity, it is, for example, estimated that subfield frequency needs to be increased to 180 Hz or more. That is, considerably high field frequency is necessary for increasing the number of fields in order to reduce color breaking to a detection limit or lower. In at least response capability of a current liquid crystal panel, even if drive frequency of 360 Hz is achieved by using high-speed liquid crystal, since a 4-field cycle of RGBW is given by inserting white, frequency of each color is decreased to ¼, 90 Hz. Color breaking may not be adequately reduced at such frequency. While the frequency of 360 Hz is achieved by using DMD or the like in a projection-type projector other than the liquid crystal type, color breaking may still not be reduced to a detection limit or lower at such frequency.

In the technique described in Japanese Patent No. 3912999, since W to W frequency is ¼ of field frequency, a color breaking prevention effect is slight. On the other hand, when concurrent lighting is performed within a field as in the technique described in Japanese Unexamined Patent, Publication No. 2008-020758, color purity is degraded.

In the technique described in Japanese Patent No. 3878030, when consideration is made on a case, as an example, where an image portion having high color saturation such as a primary color partially exists within a screen, basic colors need to be not changed from original colors in order to keep color purity of the portion. Therefore, color breaking occurs in a black-and-white portion being another portion in the screen because RGB is divided along a time axis in the portion. This results in difficulty in combining ensuring partial color purity in a screen with removing color breaking.

In the technique described in Japanese Unexamined Patent, Publication No. 2008-310286, when a portion having high purity of a saturated color does not exist in an image, the image is defined as a mild image. In such a case, a white component is lit by color-mixture whole-surface lighting by a backlight, so that color breaking is prevented. In the related art, colored image portions having high color saturation other than the mild image are studded in one image plane. Therefore, existence of the portions having high color saturation in a screen causes reduction in chroma by color-mixture whole-surface lighting, resulting in difficulty in combining ensuring partial color purity in a screen with removing color breaking.

In addition, since modulation may not be performed in a space, various techniques of reducing color breaking are investigated by various kinds of processing on a time axis in order to prevent color breaking while removing color filters. However, since surface-sequential image groups, which are perfectly separated into RGB, have no cross-field correlation in color, color breaking necessarily occurs in the present situation. Consequently, only the following methods have been used as an effective measure for preventing color breaking: a method of mixing white at the sacrifice of color purity, and a method of compensating little cross-frame correlation by increasing field frequency, for example, increasing field frequency to insert white frames.

Furthermore, Japanese Unexamined Patent, Publication No. 2007-264211 describes luminance on a retina while using various space-time diagrams and various retina diagrams. Moreover, it is described that K is assumed as a black screen, and color breaking is decreased by a configuration of RGBKKK. In Japanese Unexamined Patent, Publication No. 2007-264211, a figure showing luminance distribution on a retina is depicted to be a center-symmetric trapezoidal shape while an objective image is decomposed into integration of RGB images having different luminance. However, since a composition object is a primary-color image instead of a black-and-white image having a uniform luminance component, lateral luminance along an eye-tracking reference on a retina is actually not shaped to be center-symmetric unlike the figure. That is, the figure is insufficient in preciseness. Actually, such luminance distribution is expected to be insufficiently balanced in luminance as shown in FIG. 5 of this application described later. As a result, in the technique described in Japanese Unexamined Patent, Publication No. 2007-264211, color difference and luminance difference occurring between the front and the back in an image movement direction are visually perceived as shift in color and luminance, and therefore effectiveness is small compared with a display method described later as proposed by this application.

The related art described in Japanese Unexamined Patent, Publication No. 2008-510347 is based on an idea where a measure is taken in such a manner that a movement portion of a picture signal is detected, and a display picture side is displayed while being shifted in a movement direction in advance for the purpose of correcting shift in image on a retina occurring in moving-image tracking view. The method is effective in a period where tracking view is performed to the relevant portion. However, tracking view is merely performed based on a subject of an observer. Therefore, the method has a serious difficulty that color breaking is perceived in a further degraded sense because of processing of adding shift to even a picture originally having no shift, for example, a picture being fixedly viewed, or a picture concurrently showing plural objects moving in different directions. Therefore, the method is hard to be practically used.

Japanese Patent No. 3977675 describes an idea that RGBYeMgCy is distributed at the sixfold speed. The idea is lacking in a concept of a luminance center with respect to eye tracking. It has been confirmed by an experiment of the inventor of this application that the idea is actually not effective as a measure against color breaking compared with a display method described later as proposed by this application.

As hereinbefore, while various proposals have been made to suppress color breaking in the past, any of the proposals do not adequately consider image formation balance in luminance on a retina. Therefore, when moving-image tracking view is performed, luminance distribution on a retina becomes asymmetric, and consequently color breaking may not be sufficiently suppressed.

In view of foregoing, it is desirable to provide an image display device and an image display method, in which color breaking may be suppressed in moving-image tracking view in the field sequential method.

An image display device according to an embodiment of the invention includes a display control section decomposing each frame of input image into a plurality of field images, and variably controlling display sequence of the field images within each frame period; and a display section time-divisionally displaying the field images through use of a field sequential method in accordance with the display sequence controlled by the display control section. The display control section includes a signal analyzing section analyzing color components of each frame of the input image, and obtaining a signal level of each of a plurality of color component images which are to be acquired through decomposing each frame of the input image; a fundamental-image determination section calculating a luminance level with consideration for a visibility characteristic for each of the color component images based on the signal level of each of the color component images obtained by the signal analyzing section, and determining to employ, as a fundamental image, a color component image having a highest or second highest luminance level; a signal output section obtaining a differential image by subtracting a color component of the fundamental image from each frame of the input image, decomposing the differential image into a plurality of color components, dividing each of decomposed color components into two to produce half-divided differential images each configured of half-divided color components, and then selectively outputting, as the field images, the half-divided differential images and the fundamental image to the display section; and an output-sequence determination section controlling output sequence of the field images to be outputted from the signal output section, so as to allow the fundamental image to be displayed by the display section at a middle timing of one frame period, and so as to allow the half-divided differential images to be displayed by the display section at timings before and after the middle timing for the fundamental image so that a half-divided differential image with higher luminance level with consideration for visibility characteristic is displayed at a timing closer to the timing for the fundamental image.

In the image display device according to an embodiment of the invention, a color component image having a relatively high luminance level is extracted as a fundamental image from an input image. Moreover, a differential image is obtained by subtracting color components of the fundamental image, and the differential image is decomposed into a plurality of color components. In addition, each of the decomposed differential images of respective color components is divided in two so that a signal value is halved. The half-divided differential images of respective color components and the fundamental image are selectively outputted as a plurality of field images to a display section. At that time, output sequence is controlled such that the fundamental image is displayed by the display section at a middle timing of one frame period. Moreover, the output sequence is controlled such that the half-divided differential images with higher luminance level with consideration for visibility characteristic is displayed at a timing closer to the timing for the fundamental image. Thus, an image of a color component, which is bright and high in visibility, is displayed by the display section at a middle timing of one frame period, and images of other color components are displayed temporally symmetrically in order of higher luminance.

According to the image display device or an image display method of an embodiment of the invention, a fundamental image having a high luminance level added with a visibility characteristic is extracted and displayed by the display section at a middle timing of one frame period, and other differential images are displayed temporally before and after the fundamental image in order of a higher luminance level. Therefore, luminance distribution on a retina may be shaped to be high in a central portion, and to be symmetric. This may suppress color breaking in moving-image tracking view in a field sequential method.

Other and further objects, features and advantages of the invention will appear more fully from the following description.

### BRIEF DESCRIPTION OF THE DRAWINGS

FIG. 1 is a block diagram showing a configuration example of an image display device according to an embodiment of the invention;

FIG. 2 is an explanatory diagram schematically showing image display by a field sequential method;

FIG. 3 is an explanatory diagram schematically showing a display state in the case that a moving object is displayed while decomposing an image in one frame into field images of three colors in order of R, G and B by the field sequential method, and showing luminance distribution on a retina together;

FIG. 4 is an explanatory diagram on color breaking occurring in the field sequential method;

FIG. 5 is an explanatory diagram more accurately showing luminance distribution on a retina in the display state shown in FIG. 3;

FIG. 6 is an explanatory diagram schematically showing a display state in the case that a moving object is displayed while decomposing an image in one frame into four field images of four colors in order of R, G, B and W by the field sequential method;

FIG. 7 is an explanatory diagram more accurately showing the display state shown in FIG. 6;

FIG. 8 is an explanatory diagram schematically showing luminance distribution on a retina in the display state shown in FIG. 6;

FIG. 9 is an explanatory diagram schematically showing luminance distribution on a retina in the case that display sequence of R, G and B is changed from that in the display state shown in FIG. 6;

FIGS. 10A, 10B are explanatory diagrams schematically showing a concept of extracting a common white component Wcom from RGB color picture signals;

FIG. 11 is an explanatory diagram schematically showing a relationship between display sequence of colors and distribution of quantity of light;

FIG. 12 is an explanatory diagram showing an example of an image display method according to an embodiment of the invention, which schematically shows a display state in a case where color components being bright and high in visibility are symmetrically arranged within a frame period with the common white component Wcom as a field center;

FIG. 13 is an explanatory diagram schematically showing luminance distribution on a retina in the display state shown in FIG. 12;

FIG. 14 is an explanatory diagram showing an example of an image display method according to an embodiment of the invention, which schematically shows a display state in a case where color components being bright and high in visibility are symmetrically arranged within a frame period with a common yellow component Yecom as a field center;

FIG. 15 is an explanatory diagram schematically showing luminance distribution on a retina in the display state shown in FIG. 14;

FIG. 16 is an explanatory diagram schematically showing a first method of extracting the common yellow component Yecom from RGB color signals;

FIG. 17 is an explanatory diagram schematically showing a second method of extracting the common yellow component Yecom from RGB color signals;

FIG. 18 is a flowchart showing an example of a method of determining a color component disposed in a field center;

FIG. 19 is an explanatory diagram showing a specific example of a signal level of each color component, and a luminance level calculated based on the signal level;

FIG. 20 is an explanatory diagram showing a concept of calculating a luminance level of each color component from an original image;

FIG. 21 is an explanatory diagram schematically showing a display state in a case where color components being bright and high in visibility are symmetrically arranged within a frame period with a common magenta component Mgcom as a field center;

FIG. 22 is an explanatory diagram showing a method of reducing number of fields within a frame period;

FIG. 23 is an explanatory diagram showing a human visibility characteristic in a light place;

FIG. 24 is an explanatory diagram showing a human visibility characteristic in a dark place;

FIG. 25 is an explanatory diagram showing a visibility characteristic of a person when the person has color anomaly;

FIG. 26 is an explanatory diagram showing a wavelength discriminating characteristic of a person when the person has color anomaly;

### DETAILED DESCRIPTION OF THE PREFERRED EMBODIMENTS

Hereinafter, preferred embodiments of the invention will be described in detail with reference to drawings.

General Configuration of Image Display Device

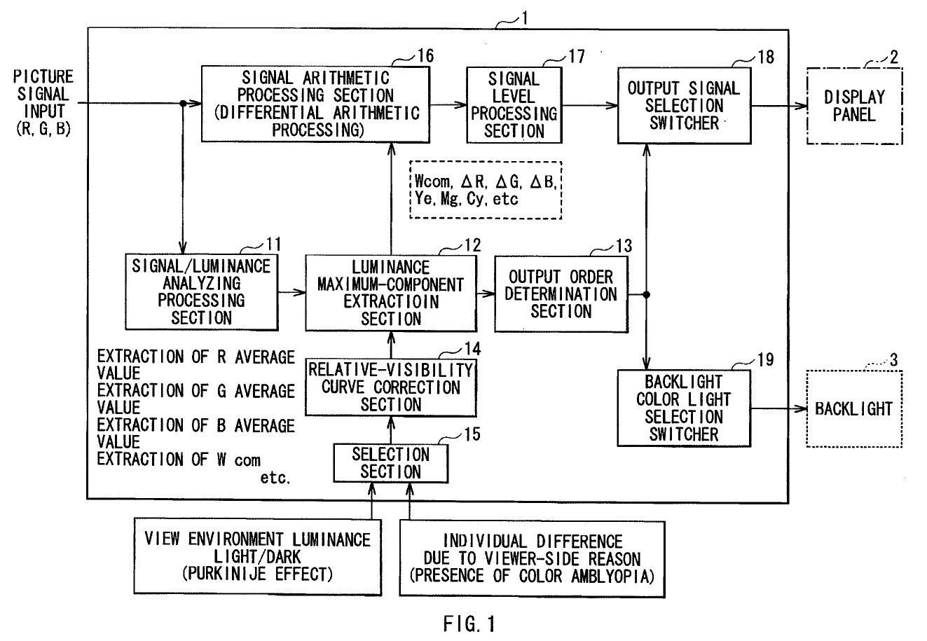

FIG. 1 shows a configuration example of an image display device according to the embodiment. The image display device has a display control section 1 to be inputted with RGB picture signals showing an input image. Moreover, the device has a display panel 2 that is controlled by the display control section 1, and performs color image display by the field sequential method, and has a backlight 3.

The display panel 2 performs image display in synchronization with light emission of each color light of the backlight 3. The display panel 2 time-divisionally displays a plurality of field images by the field sequential method according to display sequence based on control by the display control section 1. The display panel 2, for example, includes a transmissive liquid crystal panel performing image display by controlling light, which is irradiated from the backlight 3 and passes through liquid crystal molecules, by using the liquid crystal molecules. A plurality of display pixels are regularly two-dimensionally arranged on a display surface of the display panel 2.

The backlight 3 is a light source section that may time-divisionally emit a plurality of kinds of color light necessary for color image display for each color light. The backlight 3 is driven to emit light in accordance with an inputted picture signal under control by the display control section 1. The backlight 3 is, for example, disposed on a back side of the display panel 2 so as to irradiate the display panel 2 from the back side. The backlight 3 may be configured using, for example, LED (Light Emitting Diodes) as light emitting elements (light source). The backlight 3 is, for example, configured such that multiple color light may be independently surface-emitted by two-dimensionally arranging LEDs in a plane. However, the light emitting elements are not limited to LED. The backlight 3 is, for example, configured of at least a combination of red LED emitting red light, green LED emitting green light, and blue LED emitting blue light. Then, the backlight 3 is controlled by the display control section 1 so that the backlight 3 emits primary color light by independently emitting (lighting) light of each color LED, or emits achromatic-color (black-and-white) light or complementary color light in terms of additive color mixture of respective color light. Here, the achromatic color refers to black, gray or white having only brightness among hue, brightness and chroma being three attributes of color. The backlight 3 may, for example, perform light emission of yellow being one of complementary colors by turning off blue LED, and turning on red LED and green LED. Moreover, the quantity of light emission of each color LED is appropriately adjusted so that light of respective colors are concurrently emitted with appropriate color balance, thereby light emission of any color other than complementary colors and white may be performed.

Circuit Configuration of Display Control Section

The display control section 1 may decompose an input image shown by RGB picture signals into a plurality of field images in frames, and may variably control display sequence of the field images within a frame period in frames. The display control section 1 has a signal/luminance analyzing processing section 11, a luminance maximum-component extraction section 12, an output sequence determination section 13, a relative-visibility curve correction section 14, and a selection section 15. Furthermore, the display control section 1 has a signal arithmetic processing section 16, a signal level processing section 17, an output signal selection switcher 18, and a backlight color light section switcher 19.

In the embodiment, the display panel 2 corresponds to a specific example of the “display section” of an embodiment of the invention. The signal/luminance analyzing processing section 11 corresponds to a specific example of the “signal analyzing section” of an embodiment of the invention. The signal/luminance analyzing processing section 11 and the luminance maximum-component extraction section 12 correspond to a specific example of the “fundamental image determination section” of an embodiment of the invention. The signal arithmetic processing section 16, the signal level processing section 17, and the output signal selection switcher 18 correspond to a specific example of the “signal output section” of an embodiment of the invention. The output sequence determination section 13 corresponds to a specific example of the “output sequence determination section” of an embodiment of the invention.

The signal/luminance analyzing processing section 11 analyzes color components of an input image in frames, and obtains a signal level of each color component image in the case that the input image is decomposed into a plurality of color component images. While kinds of the decomposed color component images are described in detail later, the signal/luminance analyzing processing section 11 obtains a signal level of each primary-color image in the case that the input image is decomposed into only primary-color images of a red component, a green component, and a blue component as the plurality of color component images. Furthermore, the signal/luminance analyzing processing section 11 obtains a signal level of another color component image in the case that another optional color component is extracted. While a specific example is described later, for example, the section 11 obtains a signal level of a white component in the case that the white component (common white component Wcom described later) is extracted from the input image as the signal level of another color component image. Moreover, for example, the signal/luminance analyzing processing section 11 obtains a signal level of a complementary color component in the case that the complementary color component (for example, common yellow component Yecom described later) is extracted from the input image.

Moreover, the signal/luminance analyzing processing section 11 calculates a luminance level added with a visibility characteristic for each color component image based on the obtained signal level of each color component image. The luminance maximum-component extraction section 12 determines a color component image having the highest luminance level or the second-highest luminance level as a fundamental image (central image described later) based on the analysis result of the signal/luminance analyzing processing section 11. For example, a color component image is preferably selected as the fundamental image, in which when images of one frame are displayed by the display panel 2, composite luminance distribution on a retina of an observer is higher in luminance in a central portion of the distribution, and lower in luminance in the periphery of the distribution, and is decreased in width of spreading of the distribution to the utmost.

The signal/luminance analyzing processing section 11 and the luminance maximum-component extraction section 12 selectively use a certain luminance transformation equation specified from a plurality of luminance transformation equations to calculate a luminance level. For example, in SDTV, a luminance component Y is expressed by the following equation (* is a multiplication symbol).

Y=0.299*R+0.587*G+0.114*B

Strictly speaking, various transformation equations exist in accordance with various standards. However, the embodiment uses easy one for ease in understanding the description. In the luminance transformation equation, each of RGB primary-color signals is added with a typical visibility characteristic. When each of RGB primary-color signals is added with the typical visibility characteristic, the primary-color signals are converted to have a luminance ratio of about R/G/B=0.3/0.6/0.1.

As the luminance transformation equation, for example, a plurality of luminance transformation equations may be selectively used depending on view environment (light environment or dark environment). For example, at least two kinds of luminance transformation equations corresponding to photopic vision and scotopic vision may be selectively used depending on view environment. Alternatively, a plurality of luminance transformation equations may be selectively used depending on visual differences between individual observers (viewers). For example, at least two kinds of luminance transformation equations of an equation for a normal vision person and an equation for a color anomaly person may be selectively used. When view environment or presence of color anomaly such as color amblyopia is specified depending on preference of a viewer via the selection section 15, the luminance transformation equations may be appropriately changed. When a luminance transformation equation is selected in correspondence to view environment, for example, brightness of the environment may be automatically detected by a brightness sensor so that an optimal luminance transformation equation is automatically selected depending on a result of the detection. The relative-visibility curve correction section 14 instructs the signal/luminance analyzing processing section 11 and the luminance maximum-component extraction section 12 to select a luminance transformation equation in accordance with specification from the selection section 15.

The signal arithmetic processing section 16 and the signal level processing section 17 obtain a differential image by subtracting a color component of a fundamental image from an input image in frames, and decompose the differential image in a plurality of color components. Moreover, the signal arithmetic processing section 16 and the signal level processing section 17 divide the decomposed differential image of each color component into two so that a signal value is approximately halved. The output signal selection switcher 18 selectively outputs the half-divided differential images of respective color components and a fundamental image to the display panel 2 as a plurality of field images.

The backlight color light section switcher 19 controls an emission color and emission timing of the backlight 3. The backlight color light section switcher 19 controls light emission of the backlight 3 such that the backlight 3 emits light in synchronization with timing of a field image to be displayed, and appropriately emits light with color light necessary for the field image.

The output sequence determination section 13 controls output sequence of the plurality of field images to be outputted to the display panel 2 via the output signal selection switcher 18. Moreover, the output sequence determination section 13 controls emission order of emission colors of the backlight 3 via the backlight color light section switcher 19. The output sequence determination section 13 controls the output sequence and the emission order such that the fundamental image is displayed in a temporally central position within a frame period. Moreover, the output sequence determination section 13 controls the output sequence and the emission order such that the half-divided differential images of respective color components are displayed temporally before and after the fundamental image in order of a higher luminance level added with a visible characteristic. Regarding the luminance level added with a visible characteristic, when red, green and blue are exemplified, green is typically highest in visibility, and blue is typically lowest in visibility.

Display Method According to Related Art

Before describing operation (display method) of the image display device, first, a display method by the field sequential method according to a related art and difficulties thereof are described for comparison with the related art. The following description is made assuming that a typical model is used in each of a color sense characteristic and view environment except for a particular case. In the typical model, it is assumed that an observer is a normal color sense person, and an image is displayed in photopic vision environment.

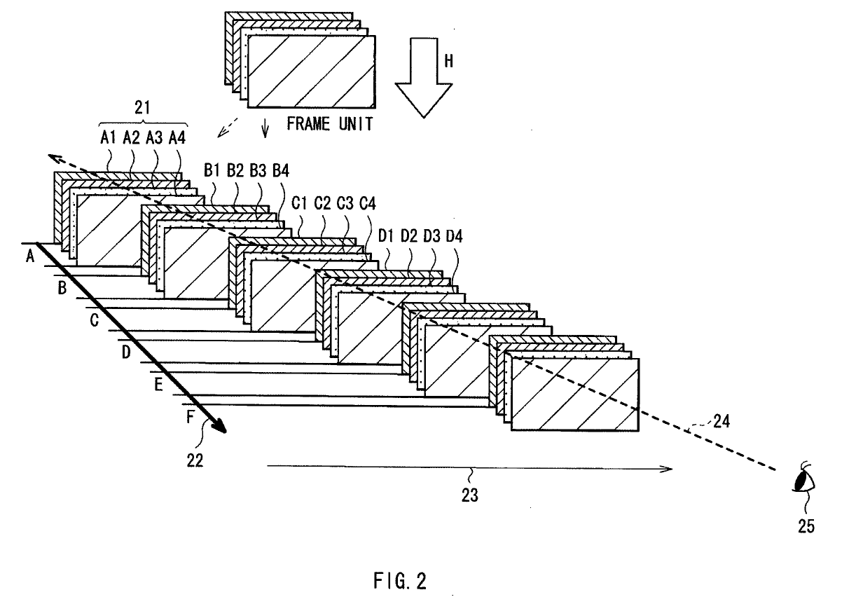

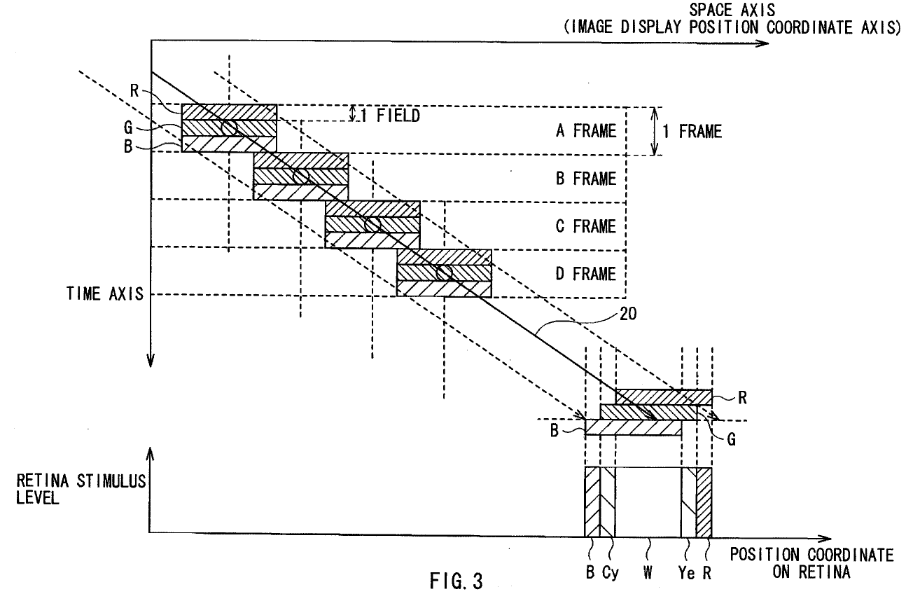

FIG. 2 shows a concept of image display by the field sequential method. In the display example, an image in a frame is decomposed into a plurality of color component image (field image) groups. FIG. 2 is a time-space diagram showing an aspect where an image group in a frame spatially moves to the right with time. In FIG. 2, frame images are shown in frame order of A, B, C, D . . . . Each frame image is divided into subfields of four colors. For example, the frame A is configured as a frame unit of a group such that the frame is divided into subfields A1, A2, A3 and A4 of four colors. An arrow 22 shows time passing, an arrow 23 shows a spatial axes (image display position coordinate axis), and an arrow 24 shows the center of observation by an observer 25 (eye-tracking reference). Such spatial representation using three-dimensional representation is not typically used, and representation is typically made using a plan view like FIG. 3 as viewed from above in an arrow H direction. Hereinafter, a representation form of FIG. 3 is used for description.

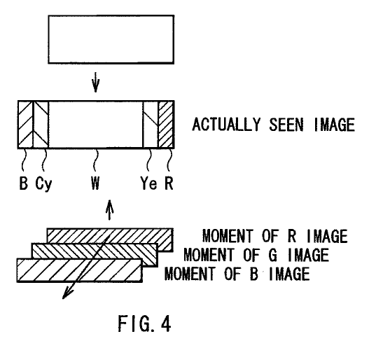

FIG. 3 shows an aspect where images in frames decomposed into RGB three fields move to the right by the field sequential method (upper stage of the figure). Respective field images are displayed in display sequence of R, G and B within a frame period. A tracking-view reference axis 20 is assumed to be in a central position of a G field image displayed in the center within a frame period. FIG. 3 further shows images superimposed during tracking view on a retina (luminance distribution on a retina) (lower stage of the figure). In the case of FIG. 3, obvious color shift called color breaking occurs in the front and the rear of the images in a moving direction. That is, when an image being originally white is moved to the right in a field configuration as shown in FIG. 3, actually, an image is seen while being separated in color at lateral ends as shown in FIG. 4.

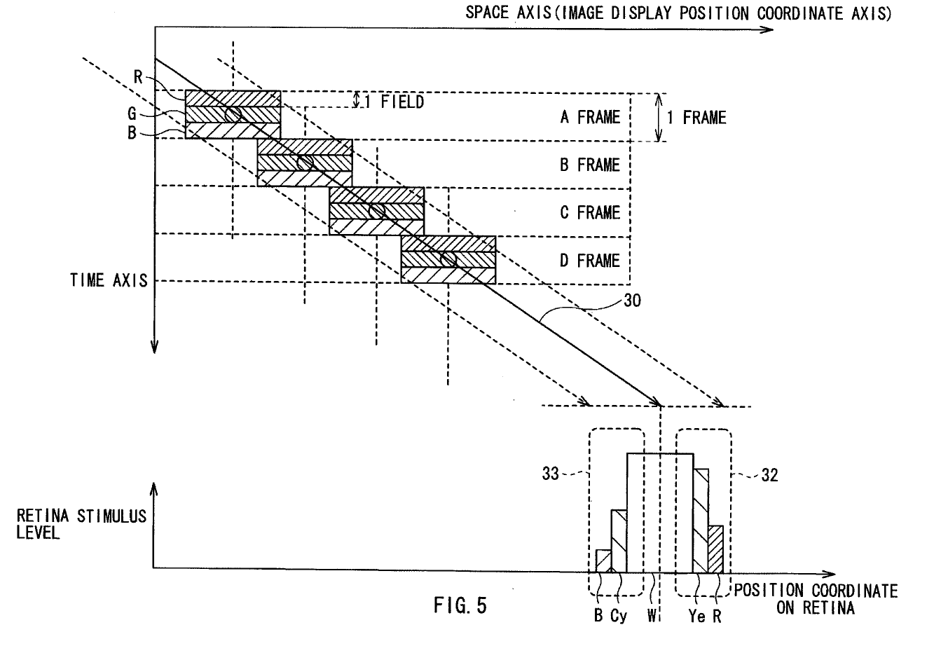

Incidentally, luminance distribution on a retina shown in the lower stage of FIG. 3 is somewhat incorrect. Thus, FIG. 5 more correctly shows luminance distribution on a retina. While “retina stimulus level” is shown as a unit of a vertical axis, the retina stimulus level may be considered to be substantially similar to luminance after visibility processing. As described before, in SDTV, a luminance component Y is roughly expressed by the following equation.

Y=0.299*R+0.587*G+0.114*B

Therefore, while luminance distribution is generally flat on a retina in FIG. 3, when a visibility characteristic is considered, correctly, luminance level distribution is different between lateral two ends as shown in FIG. 5. That is, as shown in FIG. 5, luminance distribution is different between a right region 32 where shift in yellow component Ye and shift in red component R are perceived, and a left region 31 where shift in blue component B and shift in cyan component Cy are perceived. That is, luminance energy becomes uneven on a retina composite image.

In FIGS. 3 and 5, the tracking-view reference axes 20 and 30 are meaningfully drawn through image regions of a green component G highest in luminance with consideration for a visibility characteristic. Considering the visibility characteristic, luminance of other components, that is, luminance of the red component R and luminance of the blue component B are relatively low. Since eyes unconsciously track the brightest image, the tracking-view reference axis needs to be set in a region relatively high in luminance. In an image having no green component G, since the second brightest image is a red component R image, a position of the tracking-view reference axis is close to the red component R. That is, a particular color to be tracked by eyes (brain) is the major factor.

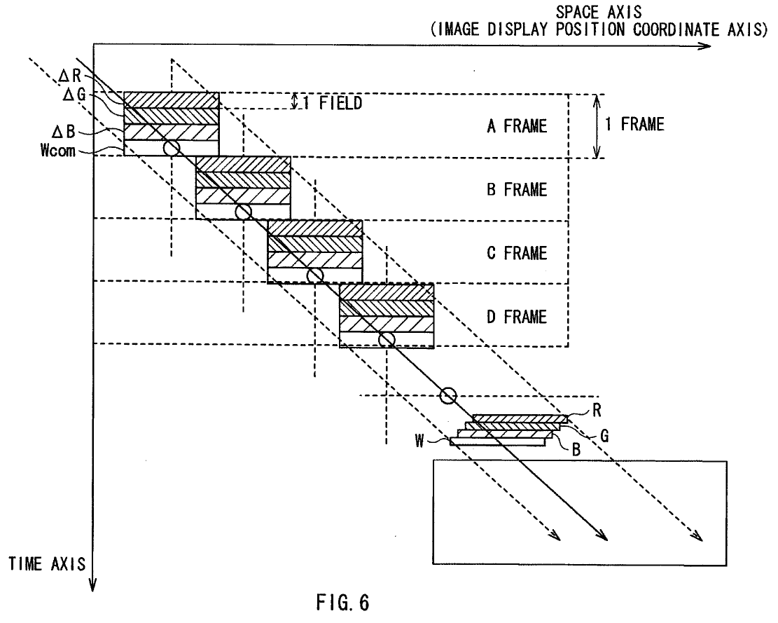

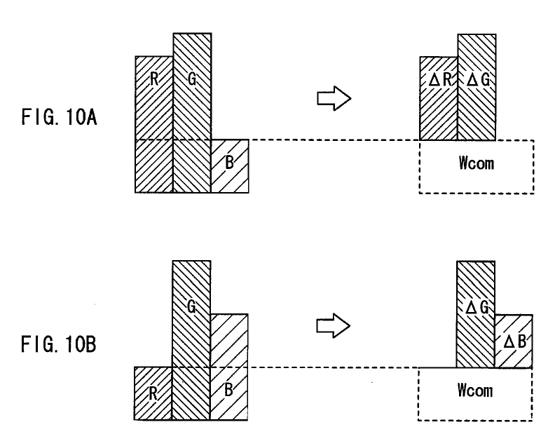

FIG. 6 shows a case where a common white component Wcom is separated and extracted from an original image, and residual components are sorted into RGB, so that field images of four colors in total are used for display in the display example of FIGS. 3 and 5. Here, the common white component Wcom is defined as an OR set of levels of colors of the lowest level portions of respective RGB components within a frame image. FIGS. 10A, 10B show an example of separation/extraction of the common white component Wcom. FIG. 10A shows an example of separation/extraction of the common white component Wcom in accordance with a level of the blue component B, and FIG. 10B shows an example of separation/extraction of the common white component Wcom in accordance with a level of the red component R. In the case of FIG. 10A, components of a differential image after separation/extraction of the common white component Wcom are a red component ΔR and a green component ΔG. In the case of FIG. 10B, components of a differential image are a blue component ΔB and a green component ΔG.

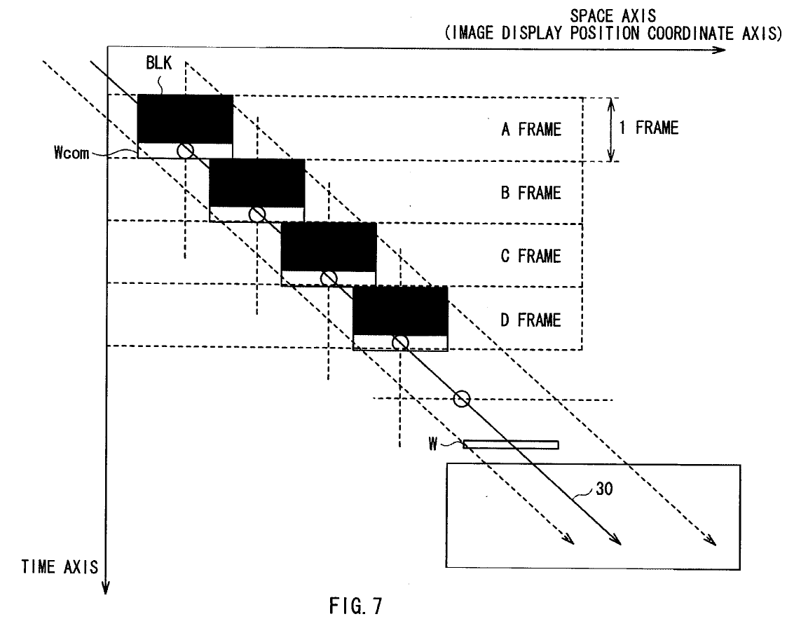

FIGS. 3 to 5 are described with a case, as an example, where RGB field images are used to compose a frame image of W (white). On the other hand, in the method of FIG. 6, when a frame image of W (white) is displayed using the common white component Wcom, correctly, display is as shown in FIG. 7. That is, as shown in FIG. 7, only the common white component Wcom is lit, and components of RGB are eliminated, leading to black display (BLK). Since this is inconvenient for description, while it may actually not occur that each of the color components is left in a constant position on an image, residual RGB components ΔR, ΔG and ΔB are assumed to exist in FIG. 6 for convenience of description. Moreover, while the tracking-view reference axis 30 is drawn on a white field in FIG. 6, the axis 30 is not necessarily formed in correspondence to the white field depending on a luminance configuration of each component of an image. The axis is drawn on the white field merely for convenience of description.

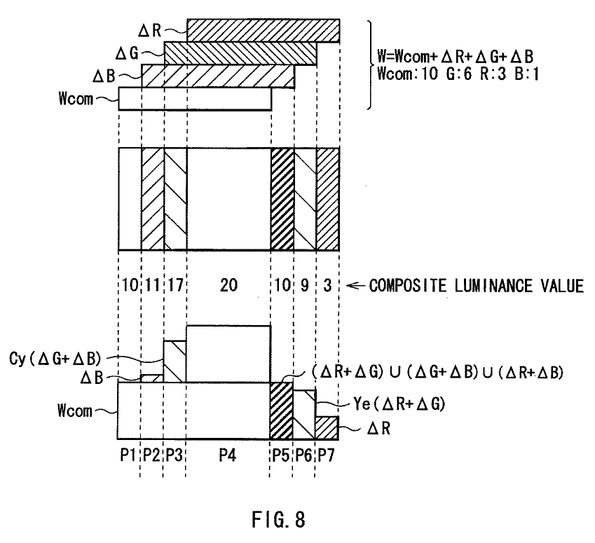

FIG. 8 shows luminance distribution on a retina in the case of the display example shown in FIG. 6. In FIG. 8, a color component W of an original image is expressed by the following equation using a common white component Wcom, a red differential ΔR, a blue differential ΔB, and a green differential ΔG.

W=Wcom+ΔR+ΔB+ΔG

A luminance ratio between respective colors is assumed as follows in consideration of the equation of the luminance component Y.

Wcom/ΔR/ΔB/ΔG=10/3/1/6

In this case, composite luminance in each of areas P1 to P7 on a retina is expressed as follows.
P1: Wcom
P2: Wcom+ΔB
P3: Wcom+ΔB+ΔG
P4: W
P5: (ΔR+ΔG)∪(ΔG+ΔB)∪(ΔR+ΔB)
P6: ΔR+ΔG
P7: ΔR

A composite luminance value in each area calculated using the above is, for example, as follows:
P1=10, P2=11, P3=17, P4=20, P5=10, P6=9 and P7=3.

Since the common white component Wcom is extracted as in the examples of FIGS. 10A, 10B, one of colors is actually lost depending on a location within a screen of one frame. Therefore, accurately, luminance distribution is not as shown in FIG. 8 at all local positions in an image. Here, FIG. 8 shows an average state of all images. Therefore, ΔR>0, ΔB>0 and ΔG>0 are not satisfied at the same time in the area P5 on a retina shown in FIG. 8 (when they are satisfied at the same time, the relevant components are at a changeable level to white, and therefore changed into the common white component Wcom). Consequently, the area P5 corresponds to an OR set component including any two colors added to each other in image distribution within a screen. As known from luminance distribution of FIG. 8, according to the method of extracting the white component, since individual primary color components of RGB are attenuated, a color breaking prevention is improved compared with the case of FIG. 5. However, color breaking is not perfectly suppressed.

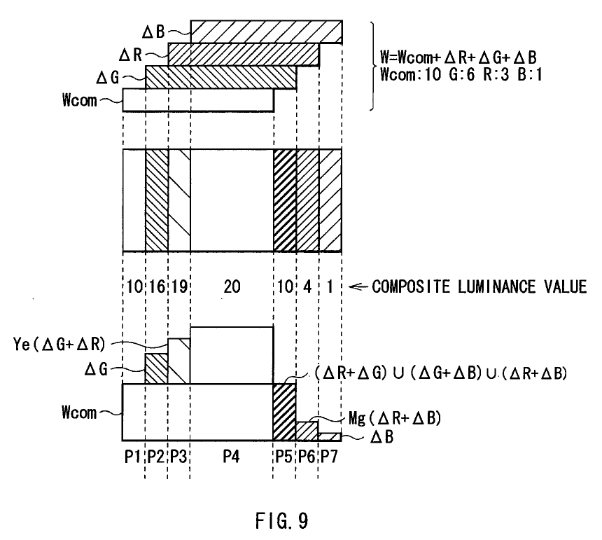

Next, FIG. 9 shows luminance distribution in a display example similar to the display example of FIG. 8. The display example of FIG. 9 is similar to the display example of FIG. 8 in that the common white component Wcom is used, but different in display sequence of residual components of RGB, ΔR, ΔG and ΔB. That is, the residual components ΔR, ΔG and ΔB are displayed in such a manner that a component having lower luminance (lower visibility) is temporally previously displayed, namely, displayed in order of a blue differential ΔB, a red differential ΔR, and a green differential ΔG. Finally, the common white component Wcom is displayed.

In the case of the display example of FIG. 9, composite luminance in each of areas P1 to P7 on a retina is expressed as follows.
P1: Wcom
P2: Wcom+ΔG
P3: Wcom+ΔG+ΔR
P4: W
P5: (ΔR+ΔG)∪(ΔG+ΔB)∪(ΔR+ΔB)
P6: ΔR+ΔB
P7: ΔB

A composite luminance value in each area calculated using the above is, for example, as follows:
P1=10, P2=16, P3=19, P4=20, P5=10, P6=4 and P7=1.
   A luminance ratio between the colors is the same as in the case of FIG. 8.

In the display example of FIG. 9, the color components are displayed in lower luminance order, so that luminance energy is biased to a side of the common white component Wcom, leading to reduction in color breaking compared with the example shown in FIG. 8. However, color breaking is still not perfectly suppressed.

Display Method of the Embodiment

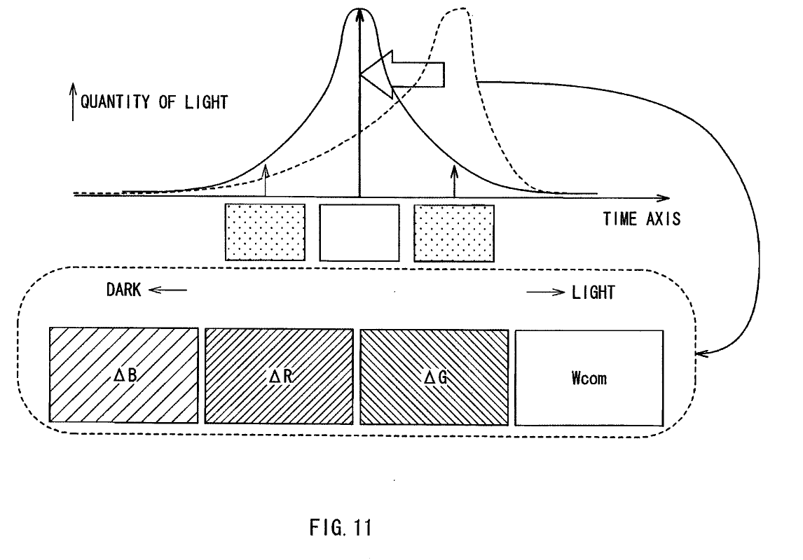

A display method of the embodiment is described on the basis of the display method of the related art. In FIG. 11, a graph of quantity of light shown by a broken line schematically shows distribution of quantity of light within a frame period in the display example of FIG. 9. In the display example of FIG. 9, images are displayed in order from an image of a color component having the lowest luminance on a time axis within a frame period, and the common white component Wcom having the highest luminance is finally displayed. Therefore, luminance energy is biased to a side of the common white component Wcom, so that light quantity distribution (luminance distribution) is temporally asymmetric. If such light quantity distribution may be changed to distribution, which is high in luminance energy in the center and temporally symmetric as shown by a solid line in FIG. 11, color breaking may be considered to be suppressed. The embodiment achieves such a display method.

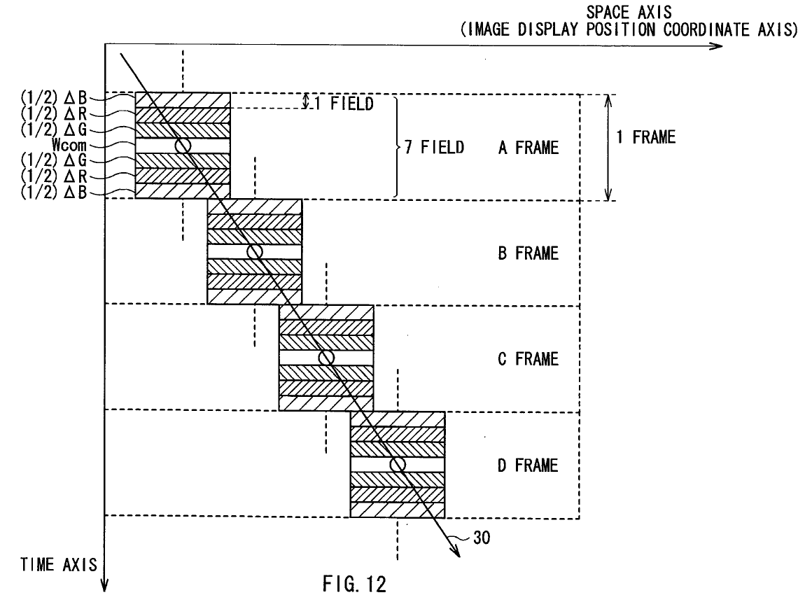

FIG. 12 shows an example of the display method, where the common white component Wcom is located in the center of fields, and color components, which are bright and high in visibility, are disposed near the center to the utmost within a frame period, and color components are generally symmetrically arranged. In the display example, the common white component Wcom is extracted from an original image, and the Wcom is displayed in the center within a frame period as a fundamental image. Moreover, differential components (½)ΔR, (½)ΔG and (½)ΔB are produced by dividing residual components ΔR, ΔG and ΔB in two so that signal value is nearly halved after extracting the common white component Wcom respectively. The differential components are displayed temporally before and after the fundamental image in order of a higher luminance level added with a visibility characteristic. That is, the green differential (½)ΔG, the red differential (½)ΔR and the blue differential (½)ΔB are sequentially displayed temporally before and after the common white component Wcom being the fundamental image (central image) in a temporally closer order to the common white component Wcom. In the display example, one frame is configured of seven fields in total including the common white component Wcom and the divided components (½)ΔR, (½)ΔG and (½)ΔB. While the embodiment describes an example where each of the residual components ΔR, ΔG and ΔB are divided in two so that a signal value is perfectly halved, the signal value may not be perfectly halved. Signal levels may be somewhat different between half-divided color components in order to finally optimize luminance distribution on a retina.

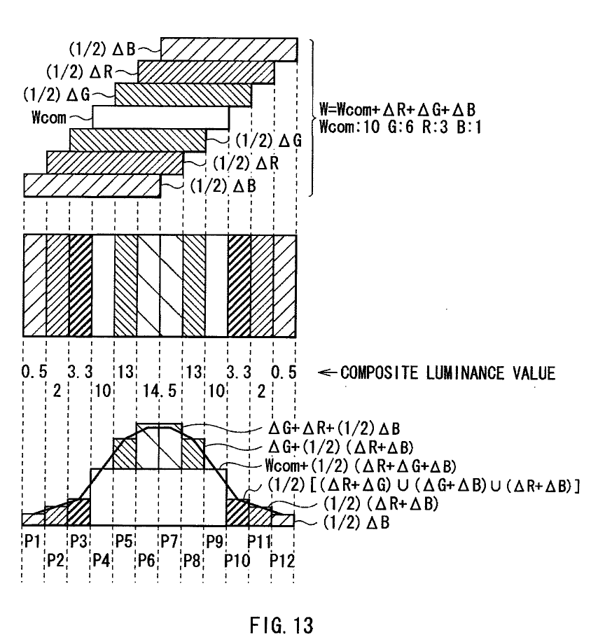

FIG. 13 shows luminance distribution on a retina in the display example. In FIG. 13, a color component W of an original image is assumed to be expressed by the following equation using the common white component Wcom, a red differential ΔR, a blue differential ΔB and a green differential ΔG.

W=Wcom+ΔR+ΔB+ΔG

A luminance ratio between the colors is assumed as follows considering the equation of the luminance component Y.

Wcom/ΔR/ΔB/ΔG=10/3/1/6

In this case, composite luminance in each of areas P1 to P12 on a retina is expressed as follows.
P1: (½)ΔB
P2: (½)(ΔR+ΔB)
P3: (½)[(ΔR+ΔG)∪(ΔG+ΔB)∪(ΔR+ΔB)]
P4: Wcom+(½)(ΔR+ΔG+ΔB)
P5: Wcom+ΔG+(½)(ΔR+ΔB)
P6: Wcom+ΔG+ΔR+(½)ΔB
P7: Wcom+ΔG+ΔR+(½)ΔB
P8: Wcom+ΔG+(½)(ΔR+ΔB)
P9: Wcom+(½)(ΔR+ΔG+ΔB)
P10: (½)[(ΔR+ΔG)∪(ΔG+ΔB)∪(ΔR+ΔB)]
P11: (½)(ΔR+ΔB)
P12: (½)ΔB

A composite luminance value in each area calculated using the above is, for example, as follows:
P1=0.5, P2=2, P3=3.3, P4=10, P5=13, P6=P7=14.5, P8=13, P9=10, P10=3.3, P11=2 and P12=0.5.

Actually, the differential components (½)ΔR, (½)ΔG and (½)ΔB are considerably low in signal level and in luminance level compared with a central image. While (½)ΔB is represented as 0.5 in a sense of schematically showing a shape of luminance distribution on a retina in FIG. 13, this is a value for convenience of description. As in the case of FIG. 8, as a result of extracting the common white component Wcom, a region where three primary colors are not shown at the same time is assumed to have the following luminance as average luminance in the case that any two colors are extracted from the three primary colors.

(½)*[(ΔR+ΔG)∪(ΔG+ΔB)∪(ΔR+ΔB)]=[(1.5+3)+(3+0.5)+(1.5+0.5)]/3=3.33

As shown in FIG. 13, the display example provides a state where a luminance peak is located approximate in the center, and luminance distribution has a symmetrical shape.

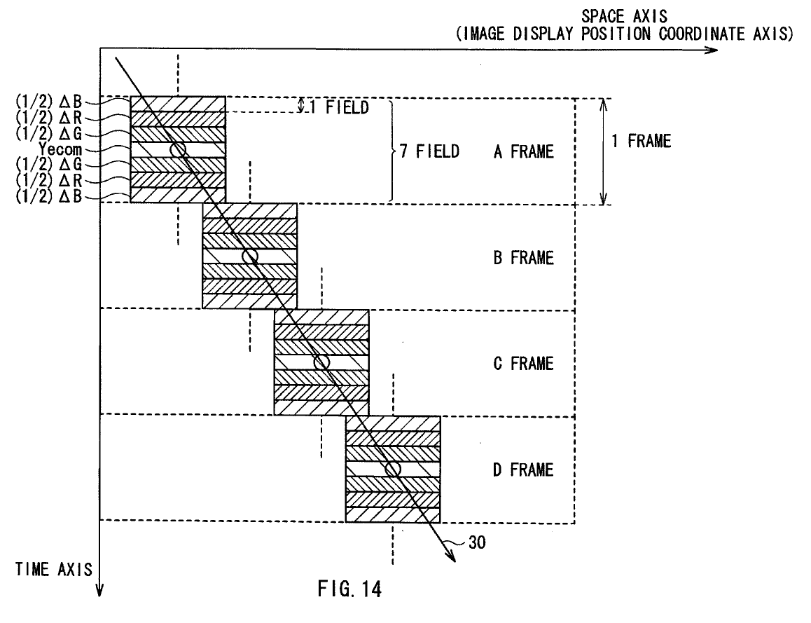

In the embodiment, the fundamental image (central image) is not limited to the common white component Wcom. A complementary color component or another optional color component may be extracted as the fundamental image. FIG. 14 shows a display example in a case where a common yellow component Yecom being a complementary color is extracted as the fundamental image. The display example is basically the same as the display example of FIG. 12 except that the common yellow component Yecom is displayed in the temporally central position in place of the common white component Wcom.

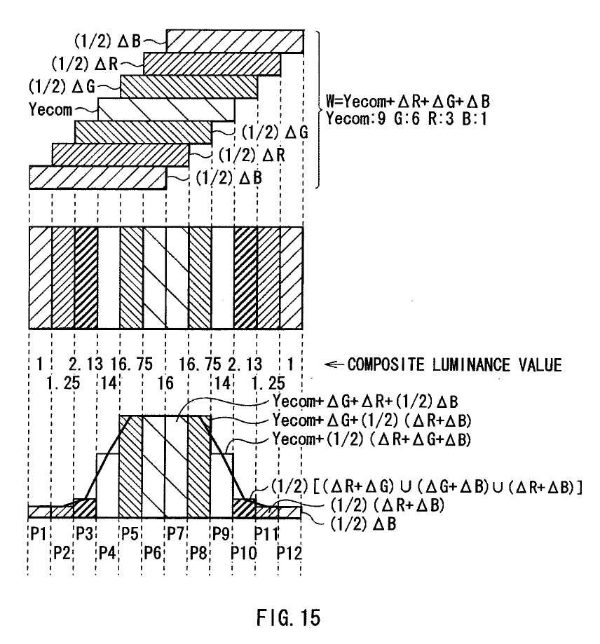

FIG. 15 shows luminance distribution on a retina in the display example. In FIG. 15, a color component W of an original image is assumed to be expressed by the following equation using the common yellow component Yecom, a red differential ΔR, a blue differential ΔB and a green differential ΔG.

W=Yecom+ΔR+ΔB+ΔG

A luminance ratio between the colors is assumed as follows considering the equation of the luminance component Y.

Yecom/ΔR/ΔB/ΔG=9/3/1/6

In calculation of composite luminance, luminance distribution is appropriately corrected depending on a picture of an image in order to cope with a phenomenon that a portion superimposed on the common yellow component Yecom is decreased in level of each of R and G, and increased in level of B (for example, a value of (½)ΔB is doubled or the like).

In this case, composite luminance in each of areas P1 to P12 on a retina is expressed as follows.
P1: (½)ΔB
P2: (½)(ΔR+ΔB)
P3: (½)[(ΔR+ΔG)∪(ΔG+ΔB)∪(ΔR+ΔB)]
P4: Yecom+(½)(ΔR+ΔG+ΔB)
P5: Yecom+ΔG+(½)(ΔR+ΔB)
P6: Yecom+ΔG+ΔR+(½)ΔB
P7: Yecom+ΔG+ΔR+(½)ΔB
P8: Yecom+ΔG+(½)(ΔR+ΔB)
P9: Yecom+(½)(ΔR+ΔG+ΔB)
P10: (½)[(ΔR+ΔG)∪(ΔG+ΔB)∪(ΔR+ΔB)]
P11: (½)(ΔR+ΔB)
P12: (½)ΔB

A composite luminance value in each area calculated using the above is, for example, as follows:
P1=1, P2=1.25, P3=2.13, P4=14, P5=16.75, P6=P7=16, P8=16.75, P9=14, P10=2.13, P11=1.25 and P12=1. The luminance values shown herein are merely values for convenience of description.

In this way, when an image is displayed with the common yellow component Yecom as the fundamental image, even if a signal level of the blue component B being low in visibility is increased, luminance is not significantly increased. Moreover, the red component R and the green component G more effectively contribute to display of the common yellow component Yecom. This increases luminance of the common yellow component Yecom being a temporally central image. In the display example, spreading of the luminance barycenter in a temporal direction is effectively reduced compared with a case where the common white component Wcom is displayed as shown in FIG. 13, and consequently color breaking is further reduced.

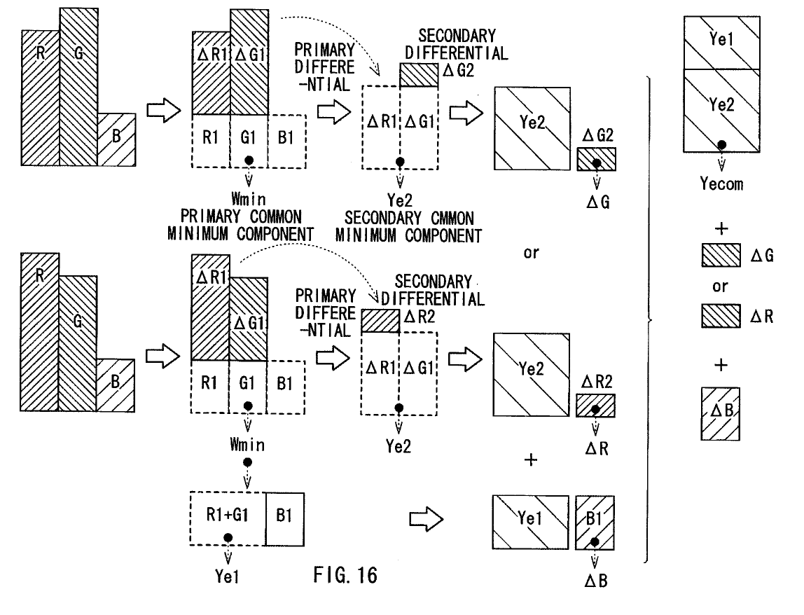

FIG. 16 schematically shows a first method of extracting the common yellow component Yecom from RGB color signals. FIG. 16 collectively shows an extraction example in a first signal configuration example where a signal level is decreased in order of G, R and B (upper stage of the figure), and an extraction example in a second signal configuration example where a signal level is decreased in order of R, G and B. In the first method, first, a white component Wmin is extracted as a primary common minimum component (R1, G1 and B1). Next, the white component Wmin is divided into a first yellow component Ye1 including R1 and G1 and a blue component B1. In addition, a second yellow component Ye2 is extracted as a secondary common minimum component of primary differential components (ΔR1, ΔG1) after extracting the white component Wmin. Then, the extracted first and second yellow components Ye1 and Ye2 are added into a final common yellow component Yecom. After the second yellow component Ye2 is extracted, a secondary differential component (ΔG2 or ΔR2) is left. Therefore, in the first signal configuration example in the upper stage of the figure, the color signals are finally divided into “Yecom+ΔG+ΔB” including the common yellow component Yecom and residual components of green and blue. In the second signal configuration example, the color signals are finally divided into “Yecom+ΔR+ΔB” including the common yellow component Yecom and residual components of red and blue.

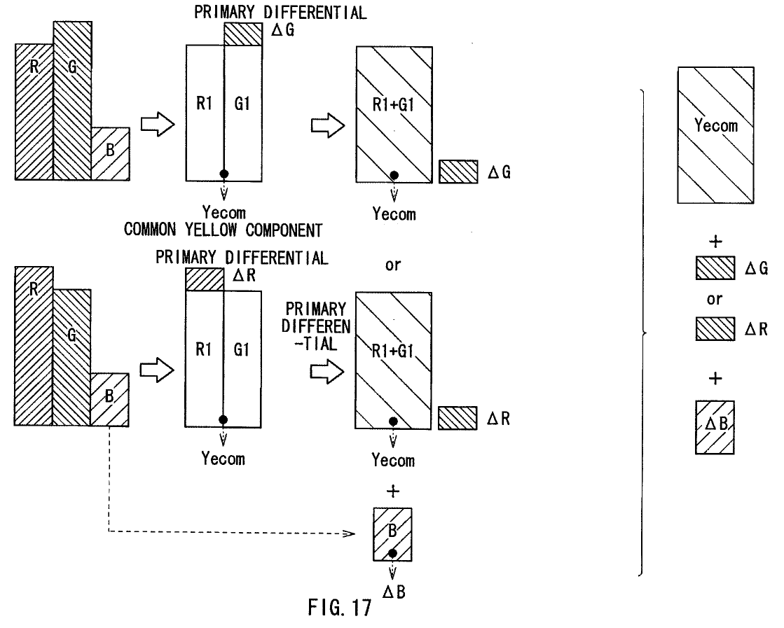

FIG. 17 schematically shows a second method of extracting the common yellow component Yecom from RGB color signals. In the first method of FIG. 16, the white component Wmin is temporarily extracted, and then the yellow component is extracted. However, the common yellow component Yecom is directly extracted without extracting the white component Wmin in the second method. In the second method, a primary differential after extracting the common yellow component Yecom directly becomes a final residual component. Finally obtained components are the same as in the case of FIG. 16.

Another complementary color (magenta component Mg or cyan component Cy) may be easily separated as a common complementary color component as in the same way as the examples of FIGS. 16 and 17.

In a usual image, a bright screen, from which a feature for eye tracking such as white or yellow may be extracted, is not continuously shown. The display method of the embodiment may meet even such a case by determining color components of a central image in the following way.

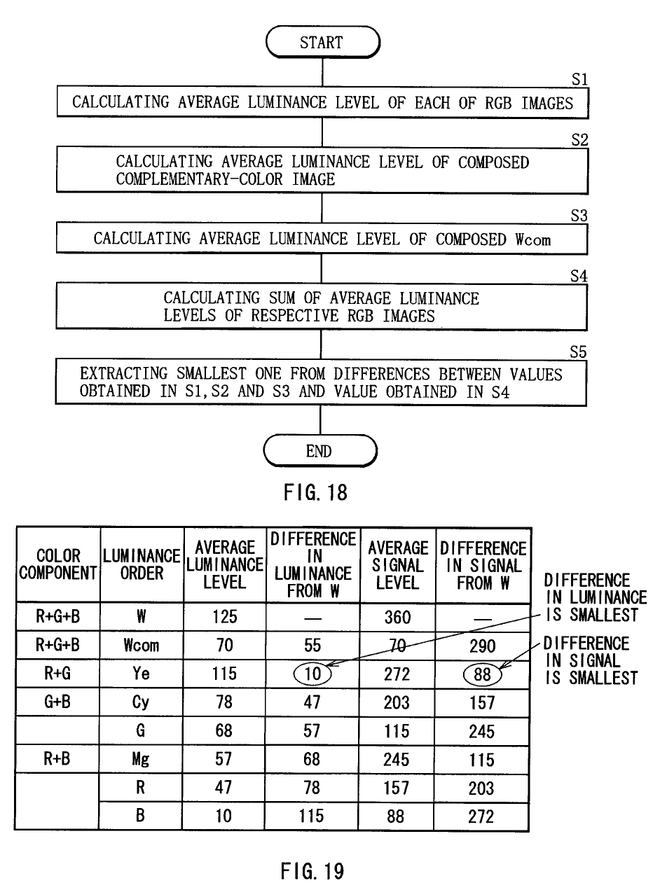

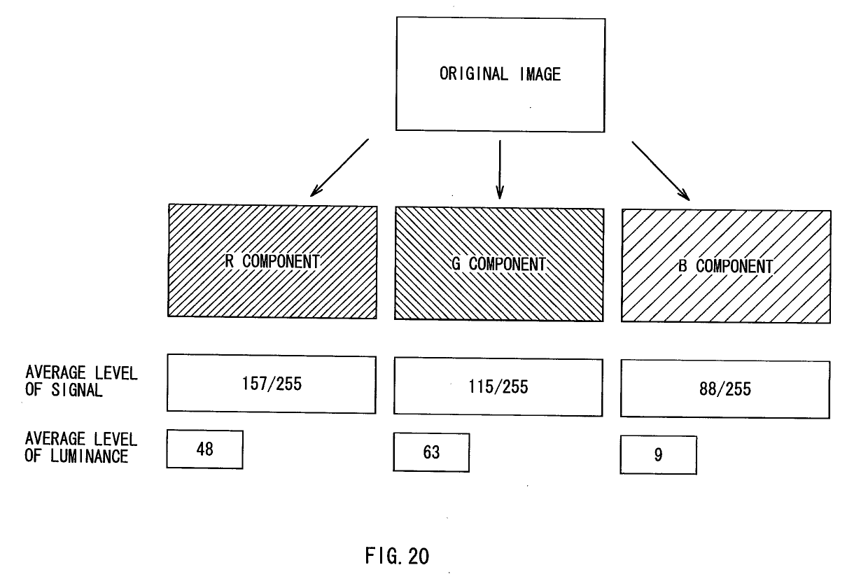

FIG. 18 shows an example of a method of determining color components of a central image disposed in a field center. FIGS. 19 and 20 show a specific example of luminance values calculated in the processing. The processing is performed by the display control section 1 in the circuit of FIG. 1. In particular, the processing is performed by the signal/luminance analyzing processing section 11 and the luminance maximum-component extraction section 12.

The display control section 1 analyzes color components of an input image in frames, and obtains a signal level of each color component image in the case that the input image is decomposed into a plurality of color component images. Here, the display control section 1 obtains an average value within a screen of each color component. Specifically, the display control section 1 obtains an average of signal levels of each primary-color image in the case that an original image is decomposed into only primary-color images of a red component, a green component and a blue component as shown in FIGS. 19 and 20. In addition, the display control section 1 obtains an average of signal levels of another optional color component when the color component is extracted. For example, the display control section 1 obtains an average of signal levels, as signal levels of another color component, in the case that the common white component Wcom is extracted. Moreover, for example, the display control section 1 obtains signal levels of a complementary-color component (the common yellow component Yecom or the like) in the case that the complementary-color component is extracted.

The display control section 1 calculates an average luminance level of each of primary-color images of red, green and blue components in frames based on the average values of the signal levels (step S1). Moreover, the display control section 1 calculates an average luminance level of a complementary-color component such as the common yellow component Yecom (step S2). Furthermore, the display control section 1 calculates an average luminance level of the common white component Wcom (step S3). Furthermore, the display control section 1 adds the average luminance levels of the primary-color images of red, green and blue, and thus obtains an average luminance level of a color component W of the original image as a whole (step S4). Finally, the display control section 1 obtains smallest one among differences between values of the average luminance levels of the respective colors obtained in the steps S1, S2 and S3, and the value of the average luminance level of the image as a whole (step S5).

A color component being smallest in difference obtained in this way is set as the fundamental image (central image). In a specific example of FIG. 19, since the common yellow component Yecom has a smallest difference in each of an average luminance level and an average signal level, the common yellow component Yecom is set as the fundamental image.

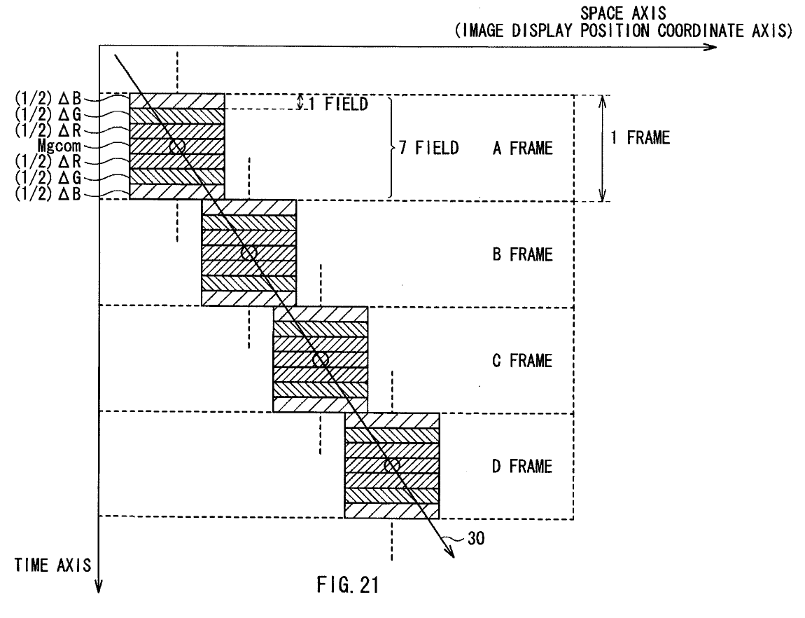

Since a fundamental image is determined by such processing, a color component other than the common white component Wcom and the common yellow component Yecom may be set as the fundamental image. FIG. 21 shows a display example in the case that a common magenta component Mgcom is set as the fundamental image. In the display example, a red differential (½)ΔR, a green differential (½)ΔG and a blue differential (½)ΔB are sequentially displayed temporally before and after the common magenta component Mgcom in a temporally closer order to the common magenta component. For example, when the amount of green component is somewhat small compared with a typical case while it is larger than the amount of blue component in luminance distribution, such a display example is given.

Field Reduction Method

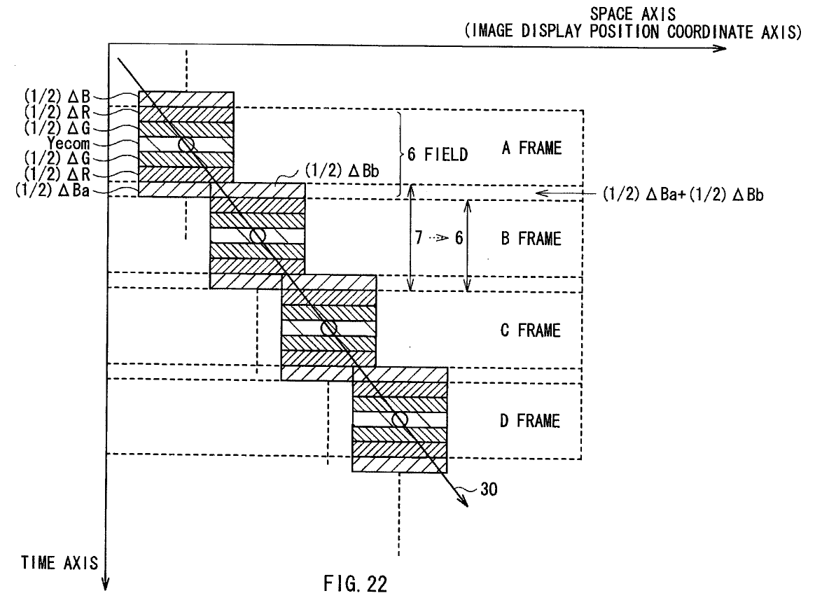

FIG. 22 shows a method of reducing the number of fields within a frame period while using the display method of the embodiment described hereinbefore. For example, when a display state as shown in FIG. 14 is given by using the display method of the embodiment, a blue component displayed in an outermost region within a frame is extremely reduced in luminance. By using this, for example, information of blue in each of successive frames A and B is shared by half by the frames, and the frames are simply added and composed to form an image. That is, when signal values of adjacent blue field images are (½)ΔBa and (½)ΔBb respectively, a composed value is as follows.

(½)ΔBa+(½)ΔBb

Such composed image is collectively displayed between adjacent frames. Thus, while number of fields per frame was seven in the display state of FIG. 14, the number may be decreased to six in the display state of FIG. 22. Such display may be achieved by the circuit of FIG. 1 in such a manner that the display control section 1 composes temporally adjacent two field images between temporally adjacent first and second frames, and performs control of collectively displaying the field images within a field period.

Display Method with Visibility Correction

Hereinbefore, the display method was described assuming that a typical model was used in each of a color sense characteristic and view environment. However, visibility correction may be achieved in consideration of difference in individual color sense characteristic or difference in view environment. The visibility correction may be achieved by appropriately modifying the luminance transformation equation used in the signal/luminance analyzing processing section 11 and the luminance maximum-component extraction section 12 in FIG. 1.

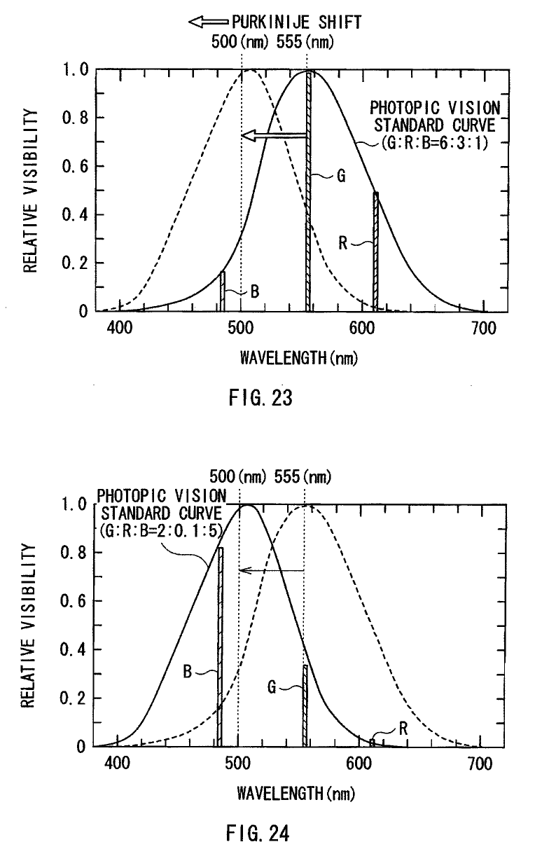

FIG. 23 shows a human visibility characteristic in a light place (photopic vision). FIG. 24 shows a human visibility characteristic in a dark place (scotopic vision). In photopic vision, the human visible characteristic has relative visibility having the largest peak at 555 nm as shown in FIG. 23. In this case, a sensitivity ratio between the primary colors R, G and B is approximately R/G/B=3/6/1. In a typical TV standard, the luminance component Y is approximately expressed by the following equation with the sensitivity ratio being added.

Y=0.3R+0.6G+0.1B

In contrast, Purkinije shift occurs in scotopic vision, leading to a relative visibility characteristic where a largest peak portion is shifted to a region near 500 nm as shown in FIG. 24. In this case, a sensitivity ratio between the primary colors R, G and B is approximately R/G/B=0.1/2/5. Therefore, the luminance transformation equation used in the signal/luminance analyzing processing section 11 and the luminance maximum-component extraction section 12 is modified into the following equation.

Y=0.1R+2G+5B

Thus, a fundamental image optimum for scotopic vision may be extracted, and display optimum for scotopic vision may be thus achieved. In actual use, such sensitivity shift of the wavelength occurs in luminance of extremely dark, special environment where darkness is too deep to distinguish colors. Therefore, such visibility correction is preferably performed only in an extreme case where ambient environment is extremely dark, and besides a display screen is extremely dark.

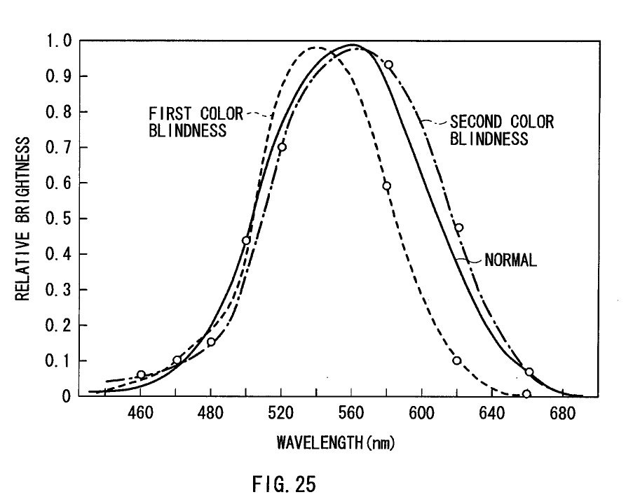

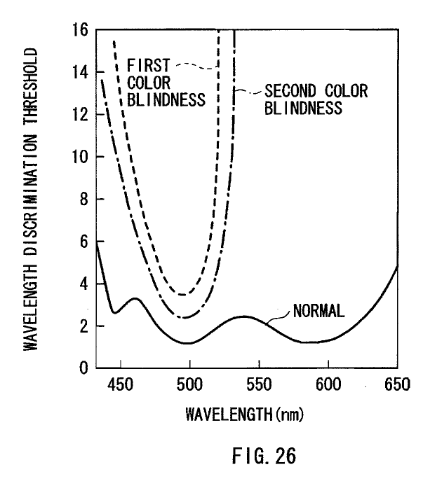

FIG. 25 shows a visibility characteristic of a person having color anomaly (first color blindness or second color blindness) in comparison with a normal person. FIG. 26 shows a wavelength-discriminating characteristic of a person having color anomaly in comparison with a normal person. As known from FIG. 25, a first color blindness person feels a red region to be dark compared with the normal person. As known from FIG. 26, a first color blindness person and a second color blindness person are hardly perform wavelength discrimination on a long wavelength side compared with the normal person. A luminance transformation equation is used, the equation being in accordance with a visibility characteristic of such typical color anomaly, which enables extraction of an optimum fundamental image in accordance with difference in individual vision characteristic is extracted, so that optimum display for individuals may be achieved.

As described hereinbefore, the display method according to the embodiment is used, thereby color breaking may be suppressed in moving-image tracking view in the field sequential method. Specifically, an image, which is bright and high in visibility, as an eye-tracking reference is used as a center, and barycenter distributing display is performed before and after the center along a time axis, so that when movement display is performed, amount of shift on a retina may be balanced, and may be equalized with respect to the barycenter of quantity of light. Thus, uneven color shift may be made inconspicuous. Particularly, while a method of correcting color shift during eye tracking by using a motion vector, or a method of reducing color breaking by inserting black is previously used, the display method of the embodiment does not use the motion vector, and does not use black insertion, and nevertheless motion error does not occur in the display method. It has been considered in the past that when a plurality of mobile objects concurrently moving in different directions exist within the same screen, a measure against color breaking may not be taken. On the other hand, in the display method of the embodiment, even if an observer performs tracking view to one mobile object, color breaking does not occur in display of another mobile object. Moreover, even if a movement direction is suddenly changed, since images superimposed on a retina are kept as they are, color breaking does not occur.

The display method has another advantage that even if a high-resolution component is provided in a high-luminance image to be a tracking-view reference, and is not provided in low-luminance image groups to be temporally symmetrically arranged, high-resolution feeling may be effectively perceived.

### Other Embodiments

The invention is not limited to the embodiment, and may be carried out in a variously modified manner.

For example, a field rate is fixed to, for example, 360 Hz, and each field period may be the same within a frame period, or a field rate may be varied within a frame period. For example, it is allowable that only a central image on a time axis and field images across the central image are displayed with a field period of 1/360 sec, and field images disposed on still outer sides of the images are displayed with 1/240 sec. That is, a field rate may be varied within a frame period as long as field images other than a central image are temporally symmetrically disposed on a time axis with the central image as the center. Even in this case, since luminance distribution on a retina finally becomes symmetric, an effect of suppressing color breaking is provided.

In the embodiment, description was made on a case where a color component image finally specified based on a luminance level was set as a central image in any case. However, a color component set for the central image may be changed within a range where luminance distribution is not significantly affected. For example, when the central image is determined based on a luminance level, yellow is best choice for the central image. However, when the central image is determined based on a signal level, white is considered to be best choice for the central image. In such a case, even if the central image is determined only based on a luminance level, it is considered that a significant difference does not exist in luminance level, for example, between yellow and white. In such a case, for example, a color component having the highest luminance level (for example, yellow) and a color component having the second highest luminance level (for example, white) may be changed in optional frames as an image to be set as the central image. For example, a frame image including “BRGWGRB” and a frame image including “BRGYeGRB” may be optionally mixedly displayed on a time axis.

The present application contains subject matter related to that disclosed in Japanese Priority Patent Application JP 2008-326539 filed in the Japan Patent Office on Dec. 22, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalent thereof.

What is claimed is:

1. An image display device, comprising:
a display control section decomposing each frame of input image into a plurality of field images, and variably controlling display sequence of the field images within each frame period; and
a display section time-divisionally displaying the field images through use of a field sequential method in accordance with the display sequence controlled by the display control section,
wherein the display control section includes
a signal analyzing section analyzing color components of each frame of the input image, and obtaining a signal level of each of a plurality of color component images which are to be acquired through decomposing each frame of the input image,
a fundamental-image determination section calculating a luminance level with consideration for a visibility characteristic for each of the color component images based on the signal level of each of the color component images obtained by the signal analyzing section, and determining to employ, as a fundamental image, a color component image having a highest or second highest luminance level,
a signal output section obtaining a differential image by subtracting a color component of the fundamental image from each frame of the input image, decomposing the differential image into a plurality of color components, dividing each of decomposed color components into two to produce half-divided differential images each configured of half-divided color components, and then selectively outputting, as the field images, the half-divided differential images and the fundamental image to the display section, and
an output-sequence determination section controlling output sequence of the field images to be outputted from the signal output section, so as to allow the fundamental image to be displayed by the display section at a middle timing of one frame period, and so as to allow the half-divided differential images to be displayed by the display section at timings before and after the middle timing for the fundamental image so that a half-divided differential image with higher luminance level with consideration for visibility characteristic is displayed at a timing closer to the timing for the fundamental image.

2. The image display device according to claim 1, wherein
the fundamental image determination section determines to employ, as a fundamental image, a color component image which satisfies such a condition that, when one frame of image is displayed by the display section, a composite luminance distribution on a retina of an observer has a profile where middle part is higher while periphery is lower, width of spreading of the composite luminance distribution being minimized.

3. The image display device according to claim 1, wherein
the signal analyzing section obtains a signal level of each of primary color images as the plurality of color component images, the primary color images being to be acquired through decomposing each frame of the input image into red, green and blue components, respectively, and
the signal analyzing section also obtains a signal level of another color component image which is configured of another optional color component and is to be extracted from each frame of the input image.

4. The image display device according to claim 3, wherein
the signal analyzing section obtains a signal level of a white component or a signal level of a complementary-color component as the another color component image, the white component and the complementary-color component being to be extracted from each frame of the input image.

5. The image display device according to any one of claims 1, wherein
the fundamental image determination section calculates a luminance level through use of a luminance transformation equation selected from a plurality of luminance transformation equations.

6. The image display device according to claim 5, wherein
the fundamental image determination section selectively uses, as the luminance transformation equation, a luminance transformation equation for photopic vision or a luminance transformation equation for scotopic vision.

7. The image display device according to claim 5, wherein
the fundamental image determination section selectively uses, as the luminance transformation equation, a luminance transformation equation for a normal vision person or a luminance transformation equation for a color anomaly person.

8. The image display device according to claim 1, wherein
the display control section puts neighboring two field images together to produce a composite field image, the neighboring two field images being included in first and second frames adjacent to each other, respectively, thereby to display the composite field image in a single field period.

9. An image display method, comprising:
a control step of decomposing each frame of input image into a plurality of field images, and variably controlling display sequence of the field images within each frame periods; and
a display step of time-divisionally displaying the field images by a display section, through use of a field sequential method in accordance with the display sequence controlled in the control step,
wherein the control step includes
a signal analyzing step of analyzing color components of each frame of the input images, and obtaining a signal level of each of a plurality of color component images which are to be acquired through decomposing each frame of the input image,
a fundamental-image determination step of calculating a luminance level with consideration for a visibility characteristic for each of the color component images based on the signal level of each of the color component images obtained in the signal analyzing step, and determining to employ, as a fundamental image, a color component image having a highest or second highest luminance level,
a signal output step of obtaining a differential image by subtracting a color component of the fundamental image from each frame of the input images, decomposing the differential image into a plurality of color components, dividing each of decomposed color components into two to produce half-divided differential images each configured of half-divided color components, and then selectively outputting, as the field images, the half-divided differential images and the fundamental image to the display section, and
an output-sequence determination step of controlling output sequence of the field images outputted from the signal output section, so as to allow the fundamental image to be displayed by the display section at a middle timing of one frame period, and so as to allow the half-divided differential images to be displayed by the display section at timings before and after the middle timing for the fundamental image so that a half-divided differential image with higher luminance level with consideration for visibility characteristic is displayed at a timing closer to the middle timing for the fundamental image.
